(19) United States
(12) Patent Application Publication
(10) Pub. No.: US 2026/0219192 A1
(43) Pub. Date: Jul. 30, 2026

(54) NANOBIONIC SERS SENSOR FOR DETECTING AIRBORNE ANALYTES, SYSTEM COMPRISING SAME, AND METHOD FOR DETECTING AIRBORNE ANALYTES

(71) Applicant: Seoul National University R&DB foundation, Seoul (KR)

(72) Inventors: Dae Hong Jeong, Seoul (KR); Seon Yeong Kwak, Seoul (KR); Yun Sik Choi, Seoul (KR); Won Ki Son, Seoul (KR)

(21) Appl. No.: 19/145,878

(22) PCT Filed: Dec. 26, 2023
(86) PCT No.: PCT/KR2023/021559

§ 371 Date: Jul. 3, 2025

(30) Foreign Application Priority Data
Jan. 6, 2023 (KR) 10-2023-0002428
Nov. 30, 2023 (KR) 10-2023-0170964

(51) Int. Cl. G01N 21/65; B82Y 20/00; B82Y 40/00; G01N 21/84

(52) U.S. Cl. CPC G01N 21/658; B82Y 20/00; B82Y 40/00; G01N 21/84; G01N 2021/8466

(57) ABSTRACT

The present invention discloses a nanobionic SERS sensor for detecting airborne analytes including an optical nanosensor disposed inside leaves of a plant, wherein the optical nanosensor comprises a first nanostructure, a second nanostructure comprising metal and being disposed on a surface of the first nanostructure to cause SERS, and a polymeric bonded to the surface of the second nanostructure and being capable of adsorbing the analytes, and wherein the optical nanosensor may be configured to detect the analytes introduced into the leaves through stomata of the plant by respiration and plant-to-plant communication mechanisms of the plant.

### TECHNICAL FIELD

The present disclosure relates to a sensor for detecting a substance, to an application thereof and to a method of detecting a substance, and more particularly to a sensor for detecting an analyte delivered by air, to an application thereof and to a method of detecting an analyte delivered by air.

### BACKGROUND ART

There is a growing demand for material detection sensors (e.g., gas sensors) that may be widely utilized in industrial sites, retail markets, daily life, environmental monitoring, smart cities, and the medical sector. Currently, gas sensors are evolving with the convergence of advanced information & communications technology (ICT) such as the internet of things (IoT), 5G, and artificial intelligence.

Korea's core technology level for gas sensors is considered to be very low compared to advanced countries (55.5% compared to the US/Europe in the material sector), and gas sensor devices are imported more than 90% of the time. In order to secure international competitiveness, the Korean government has invested KRW 150.8 billion since 2015 to develop an advanced center for the sensor industry, with the goal of achieving production worth USD 4.2 billion and exports worth USD 2.1 billion by 2020, and entering the top four sensor powers by 2025.

In the U.S., research on detecting various gases is actively underway, especially gas sensors that may operate at low temperatures with high sensitivity. In Japan, the demand for sensors that may detect polluting gases has increased dramatically since the Fukushima nuclear disaster, as people have become more aware of harmful substances, including radiation. In Europe, various projects are underway to collect and monitor data on indoor air pollution and urban air pollution.

Semiconductor gas sensors are a new generation of gas sensors that are small in size, easy to operate, simple to manufacture, and inexpensive to produce. However, they have the disadvantages of poor detection reliability when multiple gases are mixed and lack chemical durability at high temperatures. In particular, sensitivity is reduced in humid environments, making it necessary to install a separate moisture removal device.

An electronic nose is a sensor designed to detect gases through the change in current that occurs when a gas binds to a substrate. While electronic noses are the most universal technology available for detecting gases in atmospheric and laboratory environments, their sub-ppm detection limit prevents them from detecting trace (ultra-trace) compounds. In addition, since it detects gases only through changes in current, it is difficult to identify the type of gas, and the optimum detection temperature (100~300° C.) is high, which is also a limitation of the electronic nose method.

In the case of a chemical nose, various types of gaseous compounds may be detected individually by utilizing a specific binding between the receptor, including polymeric compounds, and the substance to be detected. Although chemical nose may detect each compound individually, it is difficult to detect new analytes or expand the range of analytes because it is basically a one-to-one (1:1) correspondence between the receptor and the analyte.

To replace the above-mentioned conventional gas analysis methods, spectroscopic gas detection sensors are being investigated. Current spectroscopic gas detection sensors allow the simultaneous analysis of multiple compounds individually using the results obtained through spectroscopic techniques, but require additional processing steps and additional devices for gas capture and concentration.

For the practical detection of environmental hormones, toxins, etc. that may have a significant impact on human health and the environment even in trace amounts, it is necessary to develop detection technologies that are highly sensitive and may detect multiple analytes simultaneously. In this regard, there is a need for the development of substance detection technologies that may identify the substances to be detected through spectroscopic techniques, may be utilized in situations where multiple compounds are mixed in the gas phase environment, and may monitor multiple target substances in real time.

### DISCLOSURE OF THE INVENTION

### Technical Problem

An objective of embodiments of the present disclosure is to provide a nanobionic surface-enhanced Raman scattering (SERS) sensor that may efficiently capture, concentrate, and detect airborne analytes using plant respiration and plant-to-plant communication mechanisms, without the need for additional processing steps or additional devices to capture and concentrate the analytes.

In addition, an objective of embodiments of the present disclosure is to provide a nanobionic SERS sensor that may rapidly (within a short time) detect analytes present in low concentrations (trace amounts) in air.

In addition, an objective of embodiments of the present disclosure is to provide a nanobionic SERS sensor that may detect multiple analytes in the air with high sensitivity and may monitor the occurrence, spillage, and concentration changes of a particular substance.

In addition, an objective of embodiments of the present disclosure is to provide a system/device comprising the nanobionic SERS sensor.

In addition, an objective of embodiments of the present disclosure is to provide a method for the detection of airborne analytes.

The problems intended to be solved by the present disclosure are not limited to those mentioned above, and other problems will be apparent to those skilled in the art from the following description.

### Technical Solution

According to one embodiment of the present disclosure, a nanobionic surface-enhanced Raman scattering (SERS) sensor for detecting airborne analytes, comprising: an optical nanosensor disposed inside leaves of a plant, the optical nanosensor comprising: a first nanostructure; a second nanostructure comprising metal and being disposed on a surface of the first nanostructure to cause SERS; and a polymer bonded to the surface of the second nanostructure and being capable of adsorbing the analytes, and wherein the optical nanosensor is configured to detect the analytes introduced into the interior of the leaves through stomata of the plant by respiration and inter-plant communication mechanisms of the plant.

The first nanostructure may comprise a non-metal.

The first nanostructure may have the form of a nanoparticle or a nanotube.

The first nanostructure may comprise silica or a carbon nanotube (CNT).

The second nanostructure may comprise a plurality of nanoparticles.

The second nanostructure may comprise at least one of Ag and Au.

The first nanostructure may comprise silica nanoparticles, and the second nanostructure may comprise a plurality of Ag nanoparticles disposed on a surface of the silica nanoparticles, wherein the silica nanoparticles may configure a core portion, and wherein the plurality of Ag nanoparticles may configure a shell portion.

The first nanostructure may comprise a CNT, and the second nanostructure may comprise a plurality of Au nanoparticles disposed on a surface of the CNT.

The polymeric material may comprise at least one of PDDA [poly(diallyldimethylammonium chloride)], PAA [poly acrylic acid], and PVA [poly vinyl alcohol].

The airborne analytes may include volatile organic compounds (VOCs).

The analyte delivered to the air may comprise a gas.

The airborne analytes may contain hazardous substances.

The airborne analytes may include plant-to-plant signaling substances.

The optical nanosensor may be disposed at a depth of about 15 μm or less from the leaves surface of the plant.

According to another embodiment of the present disclosure, there is provided a system comprising: a nanobionic SERS sensor for detecting the airborne analytes of any one of claims 1 to 13; and a Raman spectrometer for detecting a SERS signal generated by the nanobionic SERS sensor.

According to another embodiment of the present disclosure, a method of detecting an airborne analytes, comprising: preparing an optical nanosensor comprising a first nanostructure, a second nanostructure disposed on a surface of the first nanostructure to cause surface-enhanced Raman scattering (SERS) and comprising a metal, and a polymer bonded to a surface of the second nanostructure and being capable of adsorbing the analytes; introducing the optical nanosensor into leaves of a living plant; and measuring a SERS signal generated by the optical nanosensor introduced inside the leaves of the plant to detect the analytes has been introduced into the leaves through stomata of the plant by respiration and plant-to-plant communication mechanism from the air surrounding the plant.

The first nanostructure may comprise silica nanoparticles, and the second nanostructure may comprise a plurality of Ag nanoparticles disposed on a surface of the silica nanoparticles, wherein the silica nanoparticles may configure a core portion, and wherein the plurality of Ag nanoparticles may configure a shell portion.

The first nanostructure may comprise a carbon nanotube (CNT), and the second nanostructure may comprise a plurality of Au nanoparticles disposed on a surface of the CNT.

The polymeric material may comprise at least one of PDDA [poly(diallyldimethylammonium chloride)], PAA [poly acrylic acid], and PVA [poly vinyl alcohol].

The airborne analytes may include volatile organic compounds (VOCs).

The analyte delivered to the air may comprise a gas.

The airborne analytes may contain hazardous substances.

The airborne analytes may include plant-to-plant signaling substances.

The optical nanosensor may be disposed at a depth of about 15 μm or less from the leaves surface of the plant.

### Advantageous Effects

According to embodiments of the present disclosure, a nanobionic SERS sensor may be implemented that efficiently captures, concentrates, and detects analytes delivered into the air by utilizing plant respiration and plant-to-plant communication mechanisms, without the need for additional processing steps or additional devices to capture and concentrate the analytes. Furthermore, a nanobionic SERS sensor may be implemented that may rapidly (within a short time) detect analytes present in low concentrations (trace amounts) in the air. Furthermore, a nanobionic SERS sensor may be implemented that may detect a plurality of analytes transmitted in the air with high sensitivity, and may monitor the occurrence, spillage, concentration change, etc. of a specific substance. Furthermore, a nanobionic SERS sensor may be implemented that may qualitatively and/or quantitatively detect airborne analytes and may be utilized for real-time on-site monitoring.

Further, according to embodiments of the present disclosure, a system/device comprising the nanobionic SERS sensor may be implemented, and a method of detecting an analyte using the nanobionic SERS sensor may be implemented.

Nanobionic SERS sensors according to embodiments may be useful for the detection of harmful substances, including, for example, poisons, narcotics, and other drugs. Furthermore, the nanobionic SERS sensor and spectroscopic techniques according to embodiments may be applied to perform highly sensitive detection of various gaseous compounds. Further, nanobionic SERS sensors according to embodiments may be utilized for the detection of plant-to-plant signal transmitters. The nanobionic SERS sensors according to embodiments may be broadly utilized for the detection of various types of airborne analytes, which may be utilized in a wide range of industries. Embodiments of the nanobionic SERS sensor may be used for detecting environmental hormones, detecting hazardous material spills, standardizing air pollution levels, standardizing gas leak meter readings, detecting airborne respiratory viruses, etc.

The additional expected benefits of the technology according to embodiments of the present disclosure are summarized in technical and economic/industrial terms as follows.

### Expectations from the Technical Side

\textcircled{1} Advancement of nanosensor development technologies and expansion of research fields, including receptor discovery for target substance (analyte) detection.
\textcircled{2} Securing source technology for substance detection using nanobionic technology.
\textcircled{3} Contribute to standardization for detection of a wide range of analytes.

### Expected Economic and Industrial Benefits

\textcircled{1} Enables sensitive detection of substances that may affect human health and the environment even in trace amounts, meeting the needs of various industries that require detection of environmental substances (hazardous environmental substances).
\textcircled{2} The commercialization of nanobionic sensors may contribute to the popularization of substance detection sensors and the development of related industries.

However, the effects of the present disclosure are not limited to the above effects, and may be extended in various ways without departing from the technical ideas and scope of the present disclosure.

### BRIEF DESCRIPTION OF THE DRAWINGS

FIG. 1 illustrates a nanobionic surface-enhanced Raman scattering (SERS) sensor for detecting airborne analytes, in accordance with one embodiment of the present disclosure.

FIG. 2 is a cross-sectional view illustrating an optical nanosensor that may be applied to a nanobionic SERS sensor according to one embodiment of the present disclosure.

FIG. 3 illustrates an optical nanosensor that may be applied to a nanobionic SERS sensor and a method of fabrication thereof, in accordance with one embodiment of the present disclosure.

FIG. 4 illustrates an optical nanosensor that may be applied to a nanobionic SERS sensor and a method of fabrication thereof, in accordance with another embodiment of the present disclosure.

FIG. 5 is a transmission electron microscope (TEM) image of an optical nanosensor fabricated in accordance with one embodiment of the present disclosure.

FIG. 6 is a TEM image of an optical nanosensor fabricated according to another embodiment of the present disclosure.

FIG. 7 is a graph showing a comparison of the UV-visible extinction spectra of an optical nanosensor with AgNS functionalized with PDDA (i.e., AgNS@PDDA), an optical nanosensor with AgNS functionalized with PVA (i.e., AgNS@PVA), and an optical nanosensor with AgNS not functionalized with polymer (i.e., bare AgNS).

FIG. 8 is a graph comparing the SERS (Raman) enhancement factor for an optical nanosensor with AgNS functionalized with PDDA (i.e., AgNS@PDDA), an optical nanosensor with AgNS functionalized with PVA (i.e., AgNS@PVA), and an optical nanosensor with AgNS not functionalized with polymer (i.e., bare AgNS).

FIG. 9 is a diagram illustrating an optical nanosensor that may be applied to a nanobionic SERS sensor, in accordance with another embodiment of the present disclosure.

FIG. 10 is a graph showing the results of measuring the 4-FBT concentration dependence of the SERS intensity measured by a nanobionic SERS sensor according to embodiments of the present disclosure compared to in vitro substrates.

FIG. 11 is a graph showing the 4-FBT airborne concentration dependence of the SERS intensity measured in a nanobionic SERS sensor according to an embodiment of the present disclosure for a band at 1076 cm⁻¹.

FIG. 12 is a graph showing a comparison of the 4-FBT concentration dependence of SERS intensity between plant species used in nanobionic SERS sensors according to embodiments of the present disclosure.

FIG. 13 is a graph showing the change in SERS intensity as a function of time exposed to 4-FBT for a nanobionic SERS sensor according to an embodiment of the present disclosure and a sensor according to a comparative example.

FIG. 14 is a graph showing the results of multiplex gas detection of Raman labeled compounds, according to an embodiment of the present disclosure.

FIG. 15 is a graph showing the results of the detection of volatile compounds (i.e., methanethiol) from strawberries infected with gray mold disease (B. cinerea) using a nanobionic SERS sensor according to an embodiment of the present disclosure.

FIG. 16 is a graph showing a comparison of the SERS signals from the nanobionic SERS sensor for volatiles from control strawberry fruit (red) and gray mold-infected strawberry fruit (black) at 676 cm⁻¹.

FIG. 17 is a graph showing the SERS spectrum of gaseous nicotine detected using a nanobionic SERS sensor infiltrated with an optical nanosensor (AgNS@PVA) according to an embodiment of the present disclosure.

FIG. 18 is a graph showing the nicotine airborne concentration dependence of the SERS intensity measured by a nanobionic SERS sensor according to an embodiment of the present disclosure for a band at 1030 cm⁻¹.

FIG. 19 is a graph showing the results of detecting signaling molecules in wounded watercress using a nanobionic SERS sensor according to an embodiment of the present disclosure.

FIG. 20 is a graph showing a comparison of the SERS signals from the nanobionic SERS sensor for volatiles from control watercress (i.e., unwounded watercress) and wounded watercress.

FIG. 21 is a graph showing SERS spectra of plant-to-plant signaling molecules (volatiles) detected by a nanobionic SERS sensor according to embodiments of the present disclosure.

FIG. 22 is a graph showing SERS spectra of 10 ppm airborne nicotine and SERS spectra of volatiles (signal transmitters) from wounded tobacco plants measured using a nanobionic SERS sensor according to embodiments of the present disclosure.

FIG. 23 is a graph showing the real-time evolution of the 4-FBT SERS signal intensity on a nanobionic SERS sensor at 1076 cm-1 during incubation with 10 ppm 4-FBT.

### BEST MODE FOR CARRYING OUT THE INVENTION

Embodiments of the present disclosure will now be described in detail with reference to the accompanying drawings.

The embodiments of the disclosure described below are provided for the purpose of more clearly illustrating embodiments of the present disclosure to those having ordinary skill in the art, and the scope of embodiments of the present disclosure is not intended to be limited by the following embodiments, which may be modified in various other ways.

The terms used in this specification are intended to describe specific embodiments and are not intended to limit the disclosure. Terms used herein in the singular form may include the plural form, unless the context clearly indicates otherwise. Furthermore, the terms “comprise” and/or “comprising” as used herein are intended to specify the presence of the mentioned shapes, steps, numbers, motions, absences, elements, and/or groups thereof, and are not intended to exclude the presence or addition of one or more other shapes, steps, numbers, motions, absences, elements, and/or groups thereof. Furthermore, as used herein, the term “connected” is intended to mean not only that certain elements are directly connected, but also that they are indirectly connected by the interposition of other elements between them.

Further, when the present disclosure refers to a member being located “on” another member, this includes not only when a member is abutting another member, but also when there is another member between the two members. As used herein, the term “and/or” includes any one of the enumerated items and any combination of one or more of them. In addition, the terms “about,” “substantially,” and the like as used in the disclosure are intended to mean at or near the range of numbers or degrees, taking into account inherent manufacturing and material tolerances, and to prevent infringers from taking unfair advantage of the disclosure where precise or absolute numbers are stated, which are provided for the purpose of illustration.

Embodiments of the present disclosure will now be described in detail with reference to the accompanying drawings. The sizes or thicknesses of the areas or parts shown in the accompanying drawings may be somewhat exaggerated for clarity and ease of description. Throughout the detailed description, the same reference numerals designate the same components.

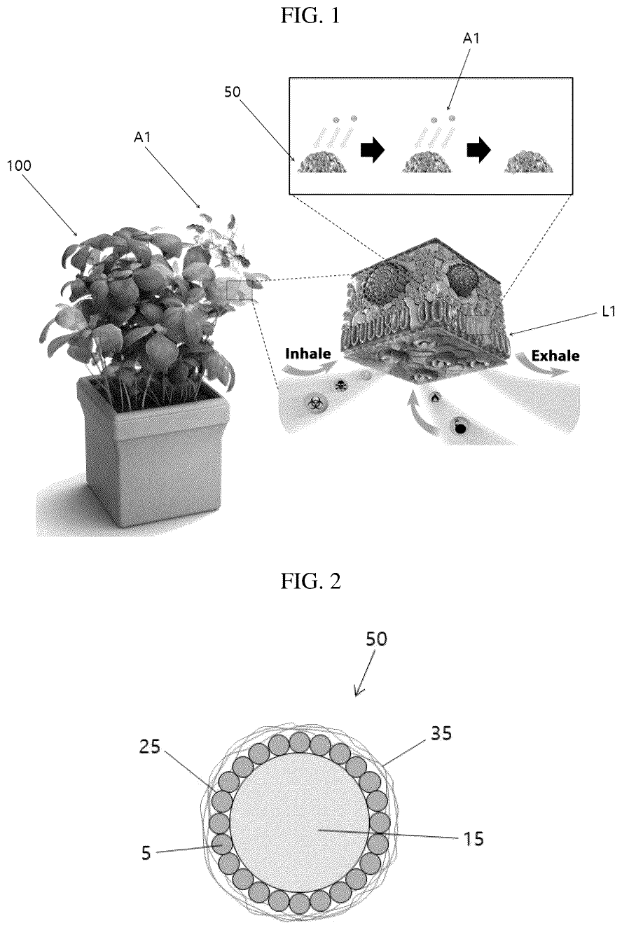

FIG. 1 illustrates a nanobionic surface-enhanced Raman scattering (SERS) sensor for detecting airborne analytes, in accordance with one embodiment of the present disclosure.

Referring to FIG. 1, a nanobionic SERS sensor for detecting airborne analyte (A1) according to embodiments of the present disclosure may include an optical nanosensor (50) disposed inside leaves (L1) of plant (100). The optical nanosensor (50) may be the to be integrated inside the leaves (L1) of the plant (100). The optical nanosensor (50) may configure a nanobionic SERS sensor in conjunction with the plant (100). Alternatively, the optical nanosensor (50) disposed inside the leaves (L1) of the plant (100) may itself be considered a nanobionic SERS sensor.

The optical nanosensor (50) may comprise a first nanostructure, a second nanostructure disposed on a surface of the first nanostructure to trigger (induce) SERS and comprising a metal, and a polymer bonded to the surface of the second nanostructure and being capable of adsorbing the analytes (A1). The structure of the optical nanosensor (50) will be described in more detail hereinafter with reference to FIG. 2.

The optical nanosensor (50) may be disposed inside the leaves (L1) of a living plant (100). The optical nanosensor (50) may be configured to detect the analytes (A1) delivered to the air drawn into the leaves (L1) through the stomata of the plant (100) by the respiration and inter-plant communication mechanisms of the plant (100). Analytes (A1) may be transferred from the air outside the plant (100) to the leaves (L1) of the plant (100), and analytes (A1) may be captured inside the leaves (L1) of the plant (100) through the stomata and absorbed on the surface of the optical nanosensor (50).

The plant (100) may serve as a substrate and housing for the optical nanosensor (50). In addition, the plant (100) may capture (suck in) and concentrate the analytes (A1) into the leaves (L1) by respiration and plant-to-plant communication mechanisms. The plant (100) may have an active process. The plant (100) may have mechanisms to communicate with other plants. The plant (100) may be sensitive to chemicals or signaling substances to quickly capture, concentrate, and recognize substances in the air. These properties of the plant (100) may be utilized to enable trace detection, high sensitivity detection, and rapid detection of the analytes (A1). The optical nanosensor (50) may be interposed into the respiration and signal transduction processes of the plant (100) such that the analytes (A1) may be captured and concentrated on the surface of the optical nanosensor (50).

Application of the nanobionic SERS sensor according to embodiments allows for efficient capture, concentration, and detection of analytes (A1) delivered in the air by utilizing the respiration and plant-to-plant communication mechanisms of plant (100), without the need for additional processing steps or additional devices to capture and concentrate the analytes (A1). Here, the respiration or plant-to-plant communication mechanism may include the process of inhalation. The nanobionic SERS sensor may not require a separate air compressor, may not require air collection by turning a fan, or may not require air capture by placing a bag or the like on the sensor.

The airborne analytes (A1) may be transferred from the air to the leaves (L1) of the plant (100). The analyte (A1) may be different from a pesticide solution or a pesticide solution that is sprayed (applied) directly onto the surface of the leaves (L1) of the plant (100). The analytes (A1) may not be sprayed directly onto and in contact with the leaves (L1) surface of the plant (100) by atomization of the solution, but may be mixed in the air from the external space of the plant (100) and delivered to the leaves (L1) of the plant (100) by air. The analytes (A1) may enter the interior of the leaves (L1) by respiration and plant-to-plant communication mechanisms of the plant (100).

The analytes (A1) delivered by air may comprise, for example, a volatile organic compound (VOC). A variety of volatile organic compounds may be the analytes (A1). The analytes (A1) delivered by air may be, for example, a gas. In other words, the analytes (A1) delivered by air may be a gaseous substance. If the analytes (A1) is a gas (gas molecule), the nanobionic SERS sensor may be a type of gas sensor. The analytes (A1) delivered in air may comprise, for example, a hazardous substance. The harmful substance may include, by way of non-limiting example, poisons, narcotics, environmental hormones, nicotine, pollutants, and the like. The airborne analytes (A1) may comprise, for example, a plant signal transmitter. The plant signal transmitters may be analyzed (measured). The airborne analytes (A1) may comprise, for example, a virus or spore. For example, an airborne respiratory virus may be analyzed (measured).

The airborne analytes (A1) may enter the interior of the leaves (L1) by respiration and plant-to-plant communication mechanisms of the plant 100, and may be captured in a region close to the surface of the leaves (L1). According to one embodiment, the optical nanosensor (50) may be preferably disposed within the epidermis region of the leaves (L1) of the plant (100). In this case, the optical nanosensor (50) may be disposed at a depth of, for example, about 15 micrometers or less from the surface of the leaves (L1) of the plant (100). The optical nanosensor (50) may not be disposed as deeply as the mesophyll region of the plant (100). As such, when the optical nanosensor (50) is disposed at a relatively shallow depth from the surface of the leaves (L1) of the plant (100), the airborne analytes (A1) may be effectively adsorbed/trapped by the optical nanosensor (50), and the detection of the analytes (A1) using the optical nanosensor (50) may be more easily performed. The optical nanosensor (50) may be disposed to infiltrate into the leaves (L1) through stomata of the plant (100).

FIG. 2 is a cross-sectional view illustrating an optical nanosensor (50) that may be applied to a nanobionic SERS sensor according to one embodiment of the present disclosure.

Referring to FIG. 2, an optical nanosensor (50), which may be applied to a nanobionic SERS sensor according to embodiments of the present disclosure, may include a first nanostructure (15), disposed on a surface of the first nanostructure (15) to trigger SERS, a second nanostructure (25), which may include a metal, and a polymeric material (35), which may be bonded to the surface of the second nanostructure (25) and capable of adsorbing airborne analytes.

The first nanostructure (15) may comprise or consist of a non-metal. In this embodiment, the first nanostructure (15) may be a dielectric (insulator). As a specific example, the first nanostructure (15) may comprise or consist of silica. In addition, in this embodiment, the first nanostructure (15) may have a nanoparticle shape. In this case, the first nanostructure (15) may have a diameter of on the order of tens of nm to hundreds of nm. For example, the diameter of the first nanostructure (15) may be greater than about 50 nm and less than about 1000 nm. However, the shape of the first nanostructure (15) is not limited to being a nanoparticle. The first nanostructure (15) may have other shapes, such as nanotubes. The first nanostructure (15) may serve as a substrate for forming the second nanostructure (25) on its surface. In addition, the first nanostructure (15) may be bonded to the second nanostructure (25) to serve to enhance the plasmonic effect.

The second nanostructure (25) may comprise a plurality of nanoparticles (5). The nanoparticles (5) may be elements for triggering (inducing) SERS for the analytes. The nanoparticles (5) may comprise or consist of metals such as Ag, Au, or the like. For example, the nanoparticles (5) may be Ag nanoparticles. The nanoparticles (5) may have a smaller size than the first nanostructure (15). The nanoparticles (5) may have a diameter of hundreds of nm or less, or tens of nm or less. For example, the diameter of the nanoparticles (5) may be more than about 1 nm and less than about 300 nm. However, this range of diameters of the nanoparticles (5) is exemplary and may vary in some cases. The plurality of nanoparticles (5) may form a single bumpy nanoshell on the surface of the first nanostructure (15). In this case, the second nanostructure (25) may be the to have a nanoshell structure. The outer diameter of the bumpy nanoshell may be, for example, greater than about 50 nm and less than about 1000 nm. The second nanostructure (25) may serve to amplify the SERS enhancement.

According to one embodiment, the first nanostructure (15) may be a silica nanoparticle, and the second nanostructure (25) may comprise a plurality of Ag nanoparticles disposed on a surface of the silica nanoparticle. In this case, the silica nanoparticles may configure a core portion, and the plurality of Ag nanoparticles may configure a shell portion. Thus, the first nanostructure (15) and the second nanostructure (25) may configure a core-shell structure. The shell portion may be referred to as an Ag bumpy nanoshell.

The polymeric material (35) may be formed on the surface of the second nanostructure (25) to serve to adsorb the analyte. The polymeric material (35) may serve to generate an attractive force that attracts the analyte to the surface of the second nanostructure (25). The polymeric material (35) may serve as a receptor that may attract the substance to be detected, i.e., the analyte, to the surface of the second nanostructure (25). It may be the that the surface of the second nanostructure (25) is functionalized by the polymeric material (35). In addition, the polymeric material (35) may serve to increase the biocompatibility of the optical nanosensor (50) to a plant organism.

The polymer (35) may have, for example, a predetermined positive charge. Such a polymer (35) may attract negatively charged analytes to be disposed in contact with or in close proximity to the surface of the second nanostructure (25). However, in some cases, the polymer (35) may also have a negative charge. Irradiation of the second nanostructure (25) with a predetermined laser, which causes surface plasmons, may cause excitation of the energized state, whereby a strong electromagnetic field may be formed within a certain range from the second nanostructure (25). The electromagnetic field may cause a significant increase in the Raman intensity by SERS of an analyte disposed in contact with or in close proximity to the second nanostructure (25).

The polymer (35) may comprise at least one of, for example, PDDA [poly(diallyldimethylammonium chloride)], PAA [poly acrylic acid], and PVA [poly vinyl alcohol]. The polymer (35) may be any one of PDDA, PAA, and PVA, or may include at least one of these. When at least one of PDDA, PAA, and PVA is applied as the polymer (35), the polymer (35) may effectively play the role of adsorbing the analyte, and as a result, the detection characteristics of the analyte using SERS may be greatly improved. In addition, when at least one of PDDA, PAA, and PVA is applied as the polymer (35), the effect of improving the biocompatibility of the optical nanosensor (50) by the polymer (35) may be improved. However, the polymer (35) is not limited to PDDA, PAA, and PVA, and may be varied, as the case may be.

The diameter or thickness of the optical nanosensor (50) according to embodiments of the present disclosure may be, for example, greater than about 20 nm and less than about 1000 nm. The length of the optical nanosensor (50) may be tens of nm or more, and in some cases, may be in the order of a few micrometers. However, these dimensional ranges of the optical nanosensor (50) are exemplary and may vary in some cases. The optical nanosensor (50) according to embodiments may utilize the plasmonic effect and may therefore be referred to as a plasmonic nanosensor.

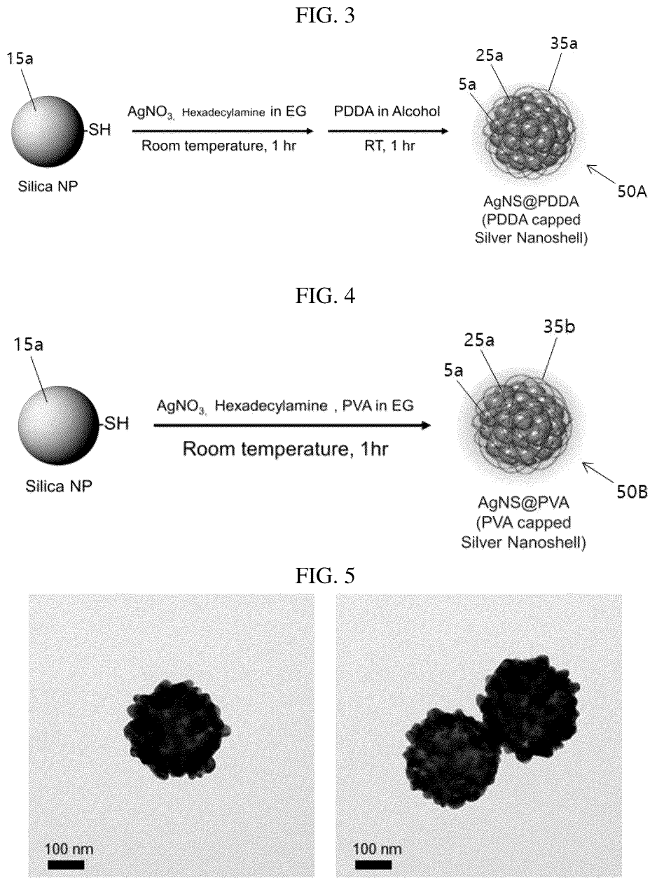

FIG. 3 illustrates an optical nanosensor (50A), which may be applied to a nanobionic SERS sensor, and a method of fabrication thereof, in accordance with one embodiment of the present disclosure.

Referring to FIG. 3, a method of fabricating an optical nanosensor (50A) according to an embodiment of the present disclosure may include the steps of preparing a first nanostructure (15a), forming a second nanostructure (25a) that is disposed on the surface of the first nanostructure (15a) and contains a metal and causes SERS, and bonding a polymeric material (35a) capable of adsorbing an analyte delivered by air to the surface of the second nanostructure (25a).

In one example, the first nanostructure (15a) may be a silica nanoparticle. The second nanostructure (25a) may comprise a plurality of Ag nanoparticles disposed on a surface of the silica nanoparticles. In this case, the silica nanoparticles may configure a core portion, and the plurality of Ag nanoparticles may configure a shell portion. The shell portion may be an Ag bumpy nanoshell (i.e., AgNS).

More specifically, the method of fabricating the optical nanosensor (50A) comprises the step of functionalizing the surface of the silica nanoparticles with a thiol group (i.e., —SH group) using 3-mercaptopropyltrimethoxysilane (i.e., MPTS), the step of forming the plurality of Ag nanoparticles using hexadecylamine and silver nitrate (AgNO₃) on the surface of the silica nanoparticles, and the step of functionalizing the surface of the plurality of Ag nanoparticles with the polymeric material. In this case, the polymeric material may be any one of PDDA, PAA, and PVA, such as PDDA.

As a first step, the silica nanoparticles (i.e., silica dielectric cores) may be synthesized according to the Stober method. 1.6 mL of tetraethyl orthosilicate (TEOS) may be dissolved in 40 mL of EtOH, and 3.5 mL of ammonium hydroxide solution may be added. After vigorously stirring this reaction mixture for 20 hours, the above silica nanoparticles, i.e., silica nanospheres (average diameter of about 150 nm), may be obtained.

Next, the prepared silica nanospheres (silica nanoparticles) (3 mg) may be washed with EtOH to remove excess reagents. Then, 50 μL of MPTS and 10 μL of ammonia hydroxide solution may be added to the silica nanospheres to functionalize the surface with thiol groups to grow Ag nanoshells. The nanoparticles (silica nanoparticles) with the above Ag nanoshells formed may be washed with EtOH to remove the free thiol groups. Next, 30 mg of AgNO₃ (silver nitrate) may be dissolved in 50 mL of ethylene glycol (EG), and then added to 60 μL of thiol-functionalized silica nanospheres in a dropwise manner. The reducing agent hexadecylamine (60.3 mg) is also added, and then lumpy Ag nanoshells (AgNS) are obtained within 1 hour. After washing with EtOH several times to remove excess reagents, the lumpy AgNS may be functionalized with PDDA polymer (15 mg) as a final step. The lumpy AgNSs may be dispersed in 30 mL of 0.05 v/v % PDDA solution, stirred for 1 hour, and washed several times with EtOH. All of the above steps may be carried out at room temperature (RT).

The optical nanosensor (50A) configured as described above may be a spherical nanoparticle having a SERS-enhanced surface of approximately 300 nm in size, the surface charge of which may be about +40 mV, and may be suitable for detecting analytes by attracting negatively charged analytes and positioning them on the SERS-enhanced surface by hydrogen bonding. Optical nanosensor (50A) may be useful for detecting trace to ultra-trace amounts of analytes.

FIG. 4 is a drawing to illustrate an optical nanosensor (50B) that may be applied to a nanobionic SERS sensor and a method of fabrication thereof, in accordance with another embodiment of the present disclosure.

Referring to FIG. 4, a method for fabricating an optical nanosensor (50B) according to an embodiment of the present disclosure may include the steps of preparing a first nanostructure (15a), forming a second nanostructure (25a) that is disposed on the surface of the first nanostructure (15a), contains a metal and causes SERS, and bonding a polymeric material (35b) capable of adsorbing airborne analytes to the surface of the second nanostructure (25a). The optical nanosensor (50B) may have a similar structure to the optical nanosensor (50A) of FIG. 4. The first nanostructure (15a) may be a silica nanoparticle. The second nanostructure (25a) may comprise a plurality of Ag nanoparticles disposed on the surface of the silica nanoparticles. In this case, the silica nanoparticles may comprise a core portion, and the plurality of Ag nanoparticles may comprise a shell portion. The shell portion may be an Ag bumpy nanoshell (i.e., AgNS).

The method of manufacturing the optical nanosensor (50B) may include the steps of functionalizing the surface of the silica nanoparticles with a thiol group (i.e., —SH group) using 3-mercaptopropyltrimethoxysilane (i.e., MPTS), forming a plurality of Ag nanoparticles using hexadecylamine and silver nitrate (AgNO₃) on the surface of the silica nanoparticles, and functionalizing the surface of the plurality of Ag nanoparticles with the polymeric material. In this case, the polymeric material may be any one of PDDA, PAA, and PVA, such as PVA.

The step of forming the plurality of Ag nanoparticles on the surface of the silica nanoparticles and the step of functionalizing the surface of the plurality of Ag nanoparticles with the polymeric material may be carried out in a continuous process. AgNO₃(silver nitrate) and hexadecylamine may be added to ethylene glycol (EG) to dissolve it, and then added to the thiol-functionalized silica nanospheres in a dropwise manner. In addition, PVA polymer may also be added to ethylene glycol (EG) and AgNS may be functionalized with PVA-containing solutions.

However, the specific fabrication methods for the optical nanosensors (50A), (50B) described with reference to FIGS. 3 and 4 are exemplary only and may be varied.

A method for detecting airborne analytes according to one embodiment of the present disclosure, comprising the steps of preparing an optical nanosensor comprising: a first nanostructure; a second nanosensor disposed on a surface of the first nanostructure to cause SERS and comprising a metal; and a polymer bonded to a surface of the second nanostructure and being capable of adsorbing the analytes, introducing the optical nanosensor into the interior of leaves of a living plant, and measuring the SERS signal generated by the optical nanosensor introduced into the interior of the leaves of the plant to detect the analytes introduced into the interior of the leaves through stomata of the plant by respiration and plant-to-plant communication mechanisms from the air surrounding the plant.

In the method of detection of analytes delivered by air, the optical nanosensor may be the same as described with reference to FIGS. 1 to 4. After preparing the optical nanosensor, the optical nanosensor (plurality of optical nanosensors) may be dispersed in a buffer solution, and then the buffer solution may be utilized to infiltrate the optical nanosensor into the leaves of a plant. The infiltration may be a solution infiltration using a solution. As a non-limiting example, the buffer solution may be an aqueous solution comprising MES [2-(N-morpholino)ethanesulfonic acid] 5 mM and MgSO₄5 mM. After infiltrating the optical nanosensor within the leaves of a plant, the optical nanosensor may be dispersed in the plant tissue as the leaves dries. The plant (living plant) with the optical nanosensor introduced inside the leaf may be used as a sensor in an environment containing gas (air). By measuring the SERS signal generated by the optical nanosensor, the analyte introduced into the leaf through the stomata of the plant by plant respiration and inter-plant communication mechanisms may be detected. The characterization of the analyte may be the same as previously described with reference to FIG. 1.

For example, upon infiltration of the optical nanosensor, 100 μL of a 0.1 mg/mL solution of silica NPs may be infiltrated onto a single leaf. Based on a clover leaf, a single leaf may have an average mass of about 17.5 mg. For example, a 100 μL buffer solution may be applied to one leaf of the plant (17.5 mg), and 0.01 mg of an optical nanosensor (plurality of optical nanosensors) may be applied to the 100 μL buffer solution. However, the specific conditions disclosed herein are exemplary only, and embodiments of the present disclosure are not limited thereto, and the infiltration conditions, the content of the optical nanosensor on the leaf, etc. may be varied.

FIG. 5 is a transmission electron microscope (TEM) image of an optical nanosensor fabricated in accordance with one embodiment of the present disclosure. The optical nanosensor of FIG. 5 may correspond to the optical nanosensor (50A) of FIG. 3, i.e., the optical nanosensor of FIG. 5 may have a structure in which an Ag nanoshell (AgNS) is formed on the surface of a silica nanoparticle and a PDDA is formed on the surface of the AgNS.

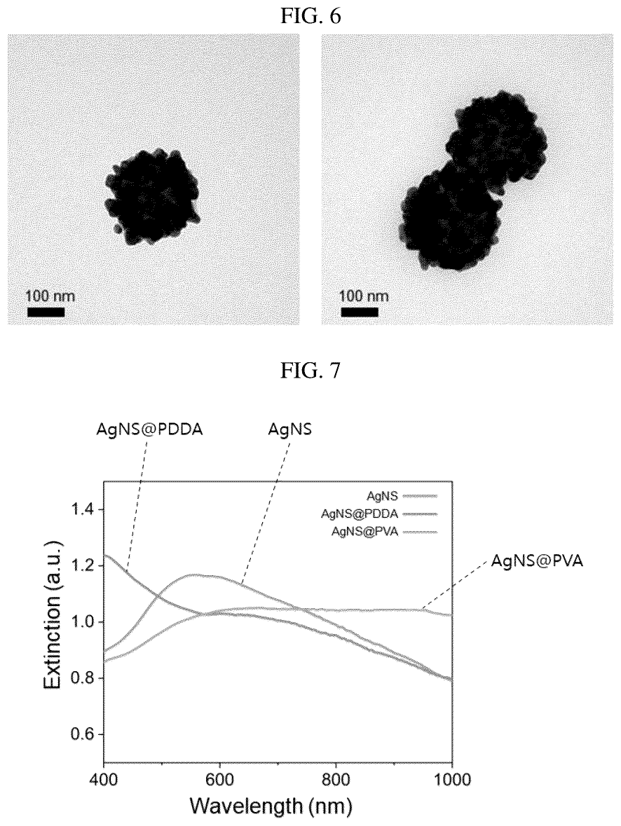

FIG. 6 is a TEM image of an optical nanosensor fabricated according to another embodiment of the present disclosure. The optical nanosensor of FIG. 6 may correspond to the optical nanosensor (50B) of FIG. 4, that is, the optical nanosensor of FIG. 6 may have a structure in which an Ag nanoshell (AgNS) is formed on the surface of a silica nanoparticle and a PVA is formed on the surface of the AgNS.

FIG. 7 is a graph showing a comparison of the UV-visible extinction spectra of an optical nanosensor with PDDA-functionalized AgNS (i.e., AgNS@PDDA), an optical nanosensor with PVA-functionalized AgNS (i.e., AgNS@PVA), and an optical nanosensor with no-functionalized AgNS (i.e., bare AgNS).

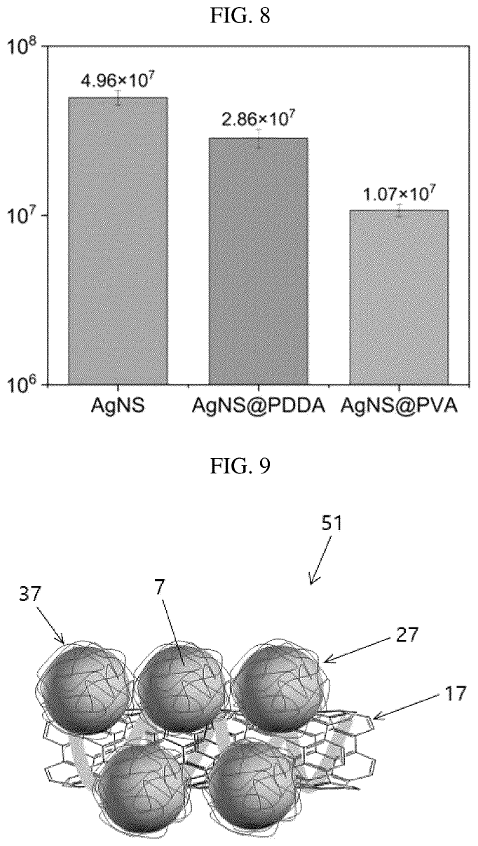

FIG. 8 is a graph showing a comparison of the SERS (Raman) enhancement factor for an optical nanosensor with PDDA-functionalized AgNS (i.e., AgNS@PDDA), an optical nanosensor with PVA-functionalized AgNS (i.e., AgNS@PVA), and an optical nanosensor with no-functionalized AgNS (i.e., bare AgNS). The SERS spectra to evaluate the Raman enhancement factor were acquired using a 785 nm laser at 2 mW.

FIG. 9 is a diagram illustrating an optical nanosensor (51) that may be applied to a nanobionic SERS sensor, according to another embodiment of the present disclosure.

Referring to FIG. 9, an optical nanosensor (51) that may be applied to a nanobionic SERS sensor according to embodiments of the present disclosure may include a first nanostructure (17), a second nanostructure disposed on a surface of the first nanostructure (17) to trigger (induce) SERS including a metal, and a polymer (37) bonded to the surface of the second nanostructure (27) and being capable of adsorbing airborne analytes.

The first nanostructure (17) may have a nanotube shape. For example, the first nanostructure (17) may be or comprise a carbon nanotube (CNT). The CNTs may include, for example, but are not limited to, single-walled carbon nanotubes (SWNTs). The first nanostructure (17) may have a length of on the order of tens of nm to several micrometers, and an outer diameter of on the order of several nm to several hundred nm. As a specific example, the first nanostructure (17) may have a length of on the order of 20 nm to 1 μm, and an outer diameter of on the order of 2 nm to 100 nm.

The second nanostructure (27) may comprise a plurality of nanoparticles (7). The nanoparticles (7) may be elements for triggering (inducing) SERS for the analytes. The nanoparticles (7) may comprise or consist of metals such as Au, Ag, or the like. For example, the nanoparticles (7) may be Au nanoparticles. The nanoparticles (7) may have a length smaller than the first nanostructure (17). The nanoparticles (7) may have a diameter of hundreds of nm or less, or tens of nm or less. For example, the diameter of the nanoparticles (7) may be more than about 1 nm and less than about 300 nm. However, this range of diameters of the nanoparticles (7) is exemplary and may vary in some cases. The plurality of nanoparticles (7) may be assembled on the surface of the first nanostructure (17). The second nanostructure (27) may serve to amplify the SERS enhancement.

In one example, the first nanostructure (17) may comprise CNTs, and the second nanostructure (27) may comprise a plurality of Au nanoparticles (7) disposed on a surface of the CNTs. The first nanostructure (17) may serve as a substrate for forming the second nanostructure (27) on its surface. The first nanostructure (17) may also serve to bond with the second nanostructure (27) to enhance the plasmonic effect.

The polymer (37) may be formed on the surface of the second nanostructure (27) to serve to adsorb the analytes. The polymer (37) may serve to generate an attractive force on the surface of the second nanostructure (27) that attracts the analytes. The surface of the second nanostructure (27) may be the to be functionalized or modified by the polymeric material (37). The polymer (37) may include, for example, at least one of PDDA, PAA, and PVA. The polymer (37) may be any one of PDDA, PAA, and PVA, or may comprise at least one of these. When at least one of PDDA, PAA, and PVA is applied as the polymer (37), the polymer (37) may effectively play the role of adsorbing the analytes, and as a result, the detection characteristics of the analyte using SERS may be greatly improved. In addition, when at least one of PDDA, PAA, and PVA is applied as the polymer (37), the effect of improving the biocompatibility of the optical nanosensor (51) by the polymer (37) may be improved. However, the polymer (37) is not limited to PDDA, PAA, and PVA, and may be varied, as the case may be.

A method of fabricating an optical nanosensor, which may be applicable to a nanobionic SERS sensor according to embodiments of the present disclosure, may include the steps of preparing a first nanostructure, forming a second nanostructure comprising a metal and causing SERS, and bonding a polymer capable of adsorbing airborne analytes to the surface of the second nanostructure. For example, the first nanostructure may comprise a carbon nanotube (CNT), and the second nanostructure may comprise a plurality of Au nanoparticles disposed on a surface of the CNT. The polymer may comprise at least one of PDDA, PAA, and PVA. The second nanostructures (nanoparticles) may be first disposed on the surface of the first nanostructures, and then the polymer may be bonded to the surface of the second nanostructures (nanoparticles). Alternatively, the polymer may be first bound to the surface of the second nanostructure (nanoparticle), and then the second nanostructure (nanoparticle) with the polymer bound thereto may be formed on the surface of the first nanostructure.

In a nanobionic SERS sensor according to embodiments of the present disclosure, a plant leaf may serve as a substrate and housing. By injecting the optical nanosensor into the leaf through the stomata of the plant and forming an interface with the plant tissue, the plant leaf may serve to capture and concentrate analytes in the gas entering through the stomata. Without the need for a separate device, the plant itself may inhale trace amounts of analytes in the air into the plant body by utilizing the plant's inherent respiratory and inter-plant communication mechanisms. As the process of adsorption of the analyte (molecule) on the surface of the optical nanosensor introduced into the plant body is repeated, even if the analyte is present in the air at a low concentration, it may be concentrated in the plant over time and detected.

In an experiment to detect an analyte using the above nanobionic SERS sensor, for example, a solution containing a volatile analyte (i.e., a solution of the analyte to be detected) may be placed in an enclosed space to allow the analyte to float in the space. A plant-based nanobionic SERS sensor may be placed in the enclosed space and exposed to the analyte. After a period of time, the SERS signal from the nanobionic SERS sensor may be measured to obtain the signal of the analyte captured and concentrated on the surface of the optical nanosensor. However, the experimental method for analyte detection may be varied.

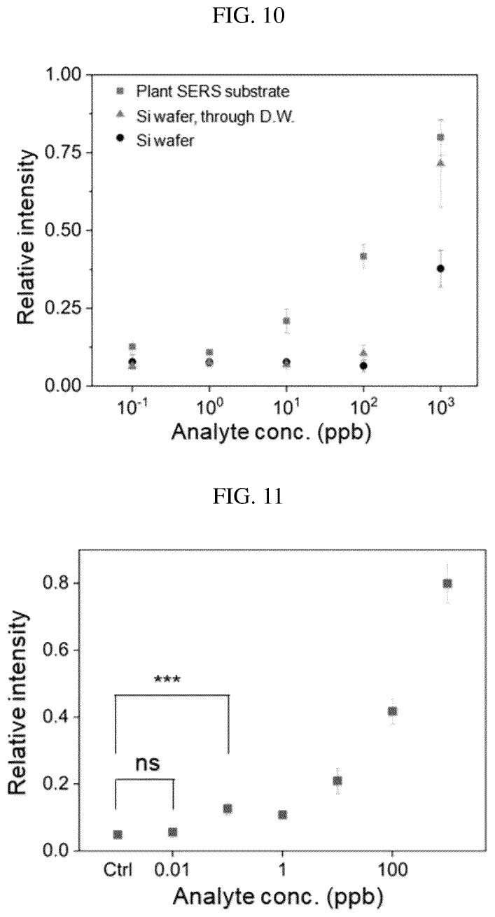

FIG. 10 is a graph showing the results of measuring the 4-FBT concentration dependence of the SERS intensity measured in a nanobionic SERS sensor according to an embodiment of the present disclosure compared to vitro substrates. Here, “Plant SERS substrate” refers to a nanobionic SERS sensor according to an embodiment of the present disclosure. “Si wafer, through D.W. (droplet water)” refers to the case where the signal for adsorption was measured on an ex vivo substrate through solvation of a water droplet, and “Si wafer” refers to the case where the optical nanosensor was placed on a Si substrate.

Referring to FIG. 10, in the case of a nanobionic SERS sensor according to an embodiment of the present disclosure, the detection limit may be about 0.1 ppb. On the other hand, the detection limit when using an in vitro Si wafer substrate was found to be as high as 100 to 1000 ppb. Therefore, using the nanobionic SERS sensor according to an embodiment of the present disclosure, an analyte may be detected with about 1000 times more sensitivity than when an optical nanosensor is applied on a general substrate.

FIG. 11 is a graph showing the 4-FBT airborne concentration dependence of the SERS intensity measured by a nanobionic SERS sensor according to an embodiment of the present disclosure for a band at 1076 cm⁻¹. Asterisks indicate values that are significantly different from the control (the control; Ctrl) (***p<0.0001, two-sided Mann-Whitney U test).

Referring to FIG. 11, it may be seen that the nanobionic SERS sensor according to an embodiment of the present disclosure allows for the detection of trace amounts of 4-FBT with gas phase concentrations on the order of 0.1 ppb.

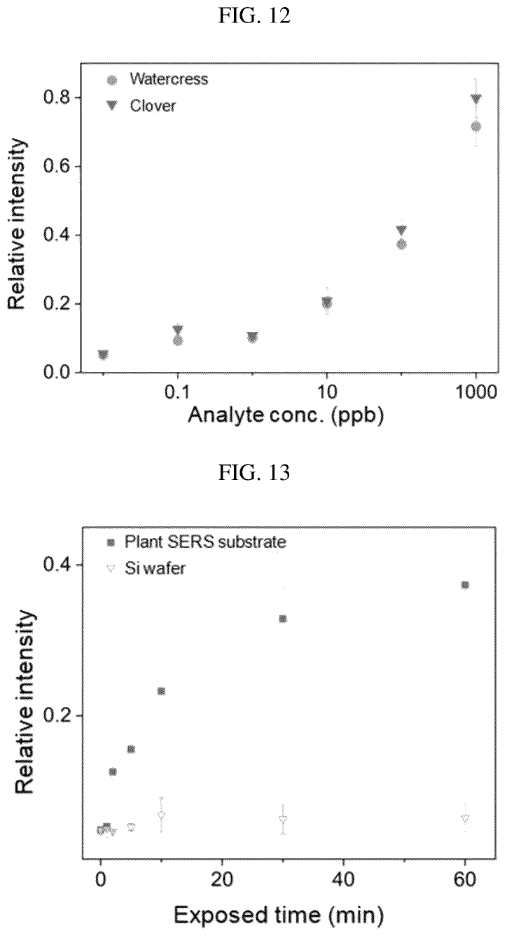

FIG. 12 is a graph showing a comparison of the 4-FBT concentration dependence of SERS intensity between plant species used in nanobionic SERS sensors according to embodiments of the present disclosure. FIG. 12 includes results for watercress and clover.

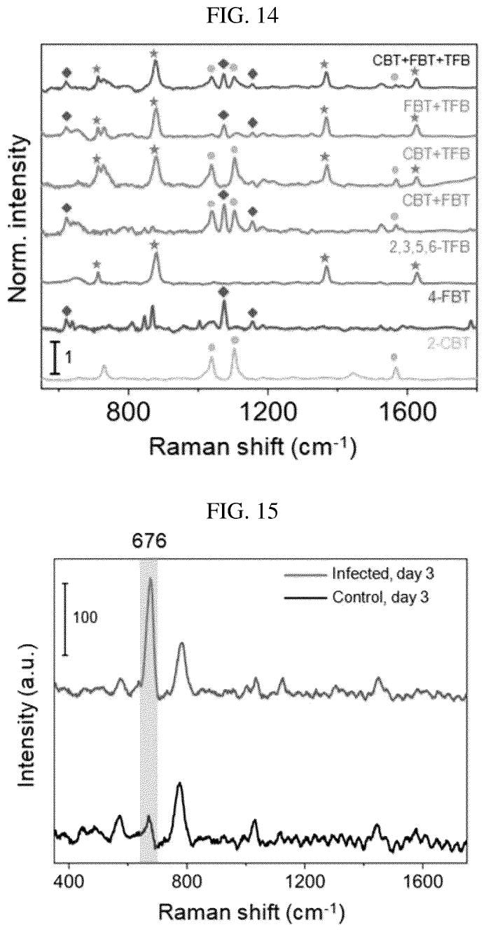

FIG. 13 is a graph showing the change in SERS intensity with time of exposure of a nanobionic SERS sensor according to an embodiment of the present disclosure and a sensor according to a comparative example to 4-FBT. Here, “Plant SERS substrate” refers to a nanobionic SERS sensor according to an embodiment of the present disclosure, and “Si wafer” (silicon wafer based in vitro substrate) refers to an optical nanosensor placed on a Si substrate according to a comparative example. The results in FIG. 13 were measured for a band at 1076 cm-1, and the airborne 4-FBT concentration was 100 ppb in all measurements.

Referring to FIG. 13, it may be seen that for the sensor according to the comparative example (Si wafer), detection was only possible after 60 minutes, while for the nanobionic SERS sensor according to the embodiment (Plant SERS substrate), a significant signal change was observed after only 2 minutes. In other words, the detection of analytes by optical nanosensors applied on Si substrates may only show signal intensity above the detection limit after exposure for about 60 minutes or more, whereas the nanobionic SERS sensor may show signal intensity above the detection limit within about 2 minutes. Thus, the nanobionic SERS sensor according to embodiments may be used to rapidly (within a short time) detect analytes present in low concentrations (trace amounts) in air.

FIG. 14 is a graph showing results of multiplex gas detection of Raman labeled compounds, in accordance with embodiments of the present disclosure. FIG. 14 includes SERS spectra of gaseous Raman label compounds and gaseous mixtures thereof. That is, FIG. 14 shows SERS spectra of 1 ppm 2-CBT (yellow), 1 ppm 4-FBT (red), 1 ppm 2,3,5,6-TFB (blue), and their mixtures, respectively 2-CBT+4-FBT (orange), SERS spectra of 2-CBT+2,3,5,6-TFB (emerald), 4-FBT+2,3,5,6-TFB (violet), and 2-CBT+4-FBT+2,3,5,6-TFB (black), respectively. Here, CBT represents chlorobenzenethiol, FBT represents fluorobenzenethiol, and TFB represents trifluorobenzene. The concentrations of each molecule in the mixture were 2-CBT 5 ppm, 4-FBT 5 ppm, and 2,3,5,6-TFB 2 ppm. The symbols indicate the characteristic bands contributed by 2-CBT (closed circles), 4-FBT (squares), and 2,3,5,6-TFB (stars).

Referring to FIG. 14, using a nanobionic SERS sensor according to embodiments of the present disclosure, simultaneous detection of multiple analytes may be possible by utilizing the narrow linewidth nature of Raman measurements. Simultaneous detection and peak separation of three or more analytes may be successfully achieved.

FIG. 15 is a graph showing the results of detecting a volatile compound (i.e., methanethiol) from strawberries infected with gray mold (B. cinerea) using a nanobionic SERS sensor according to an embodiment of the present disclosure. FIG. 15 also includes results when strawberries not infected with gray mold (B. cinerea) were used as a control. The results in FIG. 15 were measured on day 3 of the experiment.

Referring to FIG. 15, the nanobionic SERS sensor according to an embodiment of the present disclosure may be used to detect methanethiol (an example of an airborne analyte) from strawberries infected with gray mold (B. cinerea). This result was significantly different from a control using strawberries that were not infected with B. cinerea. Thus, the nanobionic SERS sensor according to an embodiment may be used for the detection of plant-to-plant spoilage.

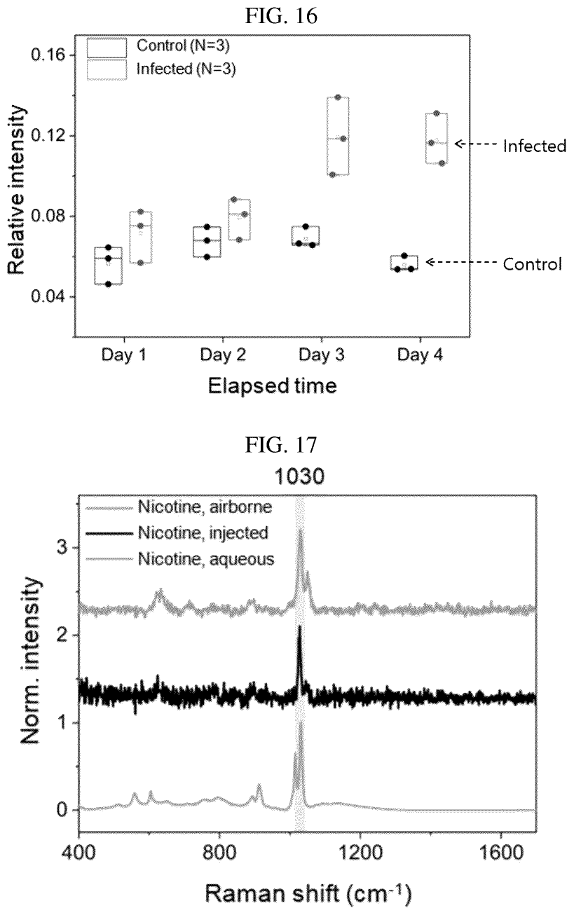

FIG. 16 is a graph showing a comparison of the SERS signals from the nanobionic SERS sensor for volatiles from control strawberry fruit (red) and gray mold-infected strawberry fruit (black) at 676 cm⁻¹. Data are from 3 individual experiments and represented as a box plot where the box ranges from the first to third interquartile with the horizontal line and small rectangular indicating median and mean, respectively.

FIG. 17 is a graph showing the SERS spectrum of gaseous nicotine detected using a nanobionic SERS sensor infiltrated with an optical nanosensor (AgNS@PVA) according to an embodiment of the present disclosure. In FIG. 17, “Nicotine, airbone” is the gaseous nicotine detected using the above nanobionic SERS sensor, “Nicotine, aqueous” is the SERS spectrum measured ex vivo for an aqueous solution, and “Nicotine, injected” is the SERS spectrum of nicotine injected into clover leaves. The airborne nicotine concentration was 100 ppm.

Referring to FIG. 17, it may be seen that gaseous nicotine may be detected using a nanobionic SERS sensor according to an embodiment of the present disclosure. The measurement results using the nanobionic SERS sensor showed that the signal shapes were consistent with the nicotine in solution (Nicotine, aqueous) and nicotine injected into the plant (Nicotine, injected).

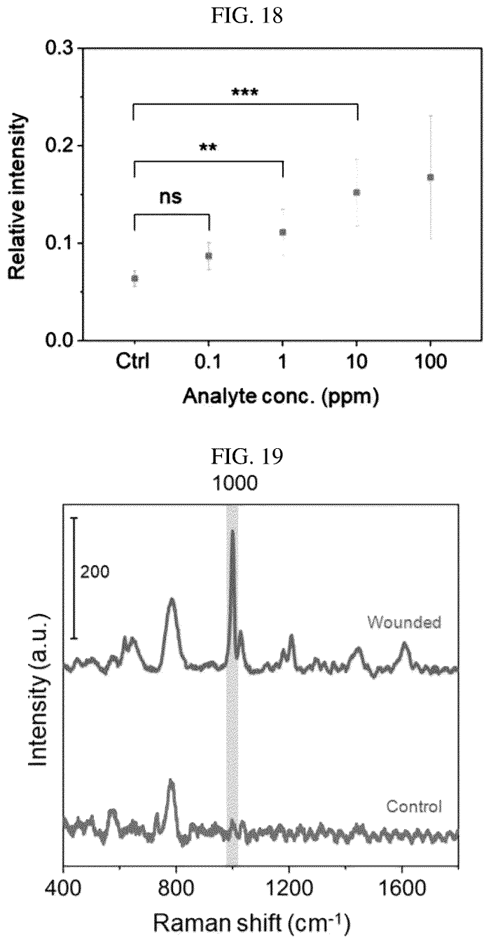

FIG. 18 is a graph showing the nicotine airborne concentration dependence of the SERS intensity measured by a nanobionic SERS sensor according to an embodiment of the present disclosure for a band at 1030 cm⁻¹. Asterisks indicate values that are significantly different from the control (**p<0.001, ***p<0.0001, two-sided Mann-Whitney U test). For nicotine, a concentration of 1 ppm airborne may be detectable.

Nanobionic SERS sensors according to embodiments of the present disclosure may be used to detect analytes corresponding to plant signaling molecules. The plant signaling substance may be referred to as a plant signaling molecule. The plant signaling molecule may be a type of volatile substance.

Plants produce a variety of signaling substances, some of which are transmitted to other plants through the air. Plants may produce a variety of signaling substances to communicate information about physical wounds, pests, environmental changes, and more. Due to the very low airborne concentrations of these signaling substances and the wide variety of them, they may be difficult to detect and distinguish using conventional techniques. However, using a nanobionic SERS sensor according to embodiments of the present disclosure, plant-to-plant signal transmitters may be easily detected.

FIG. 19 is a graph showing the results of detecting signaling molecules in wounded watercress using a nanobionic SERS sensor according to an embodiment of the present disclosure. FIG. 19 also includes results when unwounded watercress was used as a control. The spectral shapes show that PEITC is the signaling molecule that occurs in abundance in wounded watercress.

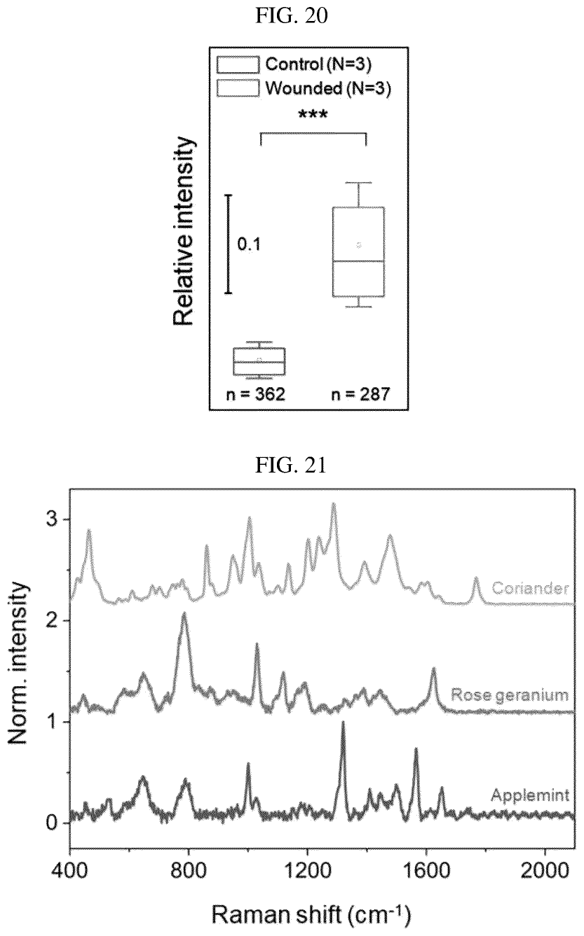

FIG. 20 is a graph showing a comparison of the SERS signals from the nanobionic SERS sensor for volatiles from control watercress (i.e., unwounded watercress) and wounded watercress.

Referring to FIG. 20, a nanobionic SERS sensor according to an embodiment of the present disclosure may be used to detect signal transmitters (an example of an airborne analyte) from wounded watercress. The results were significantly different from a control using unwounded watercress.

FIG. 21 is a graph showing SERS spectra of plant-to-plant signal transmitters (volatiles) detected by a nanobionic SERS sensor according to an embodiment of the present disclosure. The signals in FIG. 21 were obtained from the volatiles of wounded coriander (Coriandrum sativum), wounded rose geranium (Pelargonium graveolens), and wounded apple mint (Mentha suaveolens).

Referring to FIG. 21, a nanobionic SERS sensor according to an embodiment of the present disclosure may be used to facilitate the detection of signaling molecules from different types of plants. It may be seen that different signal transmitters with different spectral shapes are generated (emitted).

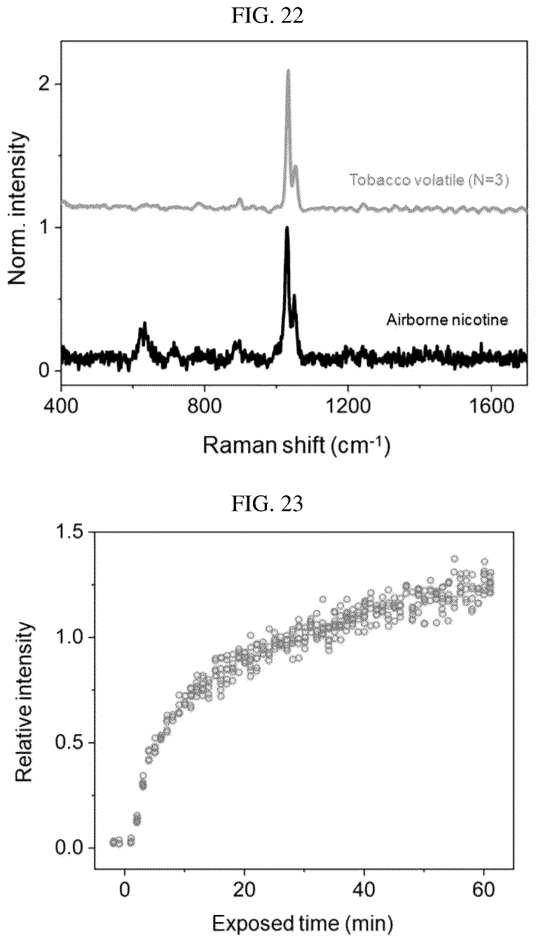

FIG. 22 is a graph showing SERS spectra of 10 ppm airborne nicotine and SERS spectra of volatiles (signal transmitters) from wounded tobacco plants measured using a nanobionic SERS sensor according to embodiments of the present disclosure.

Referring to FIG. 22, it may be seen that nicotine may be detected in wounded tobacco plants using a nanobionic SERS sensor according to an embodiment of the present disclosure.

According to an embodiment of the present disclosure, a system (apparatus) is provided comprising a nanobionic SERS sensor for detecting the airborne analytes and a Raman spectrometer for detecting SERS signals generated by the nanobionic SERS sensor.

FIG. 23 is a graph showing the real-time evolution of the 4-FBT SERS signal intensity on the nanobionic SERS sensor at 1076 cm-1 during incubation with 10 ppm 4-FBT. The 4-FBT exposure started at 0 min and five spectra were taken every minute with an acquisition time of 1 s each. Using a Raman measurement device, the signal evolution of the nanobionic SERS sensor in response to a given concentration may be observed in real time.

According to the embodiments of the disclosure described above, it is possible to implement a nanobionic SERS sensor that may efficiently capture, concentrate, and detect analytes delivered to the air by utilizing plant respiration and plant-to-plant communication mechanisms, without the need for additional processing steps or additional devices to capture and concentrate the analytes. In addition, a nanobionic SERS sensor may be implemented that may rapidly (within a short time) detect analytes present in low concentrations (trace amounts) in the air. In addition, a nanobionic SERS sensor may be implemented that may detect a plurality of analytes transmitted in the air with high sensitivity, and may monitor the occurrence, spillage, concentration change, etc. of a specific substance. In addition, a nanobionic SERS sensor may be implemented that may qualitatively and/or quantitatively detect airborne analytes and may be utilized for real-time on-site monitoring.

In addition, according to embodiments of the present disclosure, a system/device comprising the nanobionic SERS sensor may be implemented, and a method of detecting an analyte using the nanobionic SERS sensor may be implemented.

Nanobionic SERS sensors according to embodiments may be useful for the detection of harmful substances, including, for example, poisons, narcotics, and other drugs. Furthermore, the nanobionic SERS sensor and spectroscopic techniques according to embodiments may be applied to perform highly sensitive detection of various gaseous compounds. Further, nanobionic SERS sensors according to embodiments may be utilized for the detection of plant-to-plant signal transmitters. The nanobionic SERS sensors according to embodiments may be broadly utilized for the detection of various types of airborne analytes, which may be utilized in a wide range of industries. Embodiments of the nanobionic SERS sensor may be used for detecting environmental hormones, detecting hazardous material spills, standardizing air pollution levels, standardizing gas leak meter readings, detecting airborne respiratory viruses, etc.

The additional expected benefits of the technology according to embodiments of the present disclosure are summarized in technical and economic/industrial terms as follows.

### Expectations from the Technical Side

\textcircled{1} Advancement of nanosensor development technologies and expansion of research fields, including receptor discovery for target substance (analyte) detection.
\textcircled{2} Securing source technology for substance detection using nanobionic technology.
\textcircled{3} Contribute to standardization for detection of a wide range of analytes.

### Expected Economic and Industrial Benefits

\textcircled{1} Enables sensitive detection of substances that may affect human health and the environment even in trace amounts, meeting the needs of various industries that require detection of environmental substances (hazardous environmental substances).
\textcircled{2} The commercialization of nanobionic sensors may contribute to the popularization of substance detection sensors and the development of related industries.

This description discloses preferred embodiments of the present disclosure, and although certain terms are used, they are used in a general sense only to facilitate the description and understanding of the disclosure and are not intended to limit the scope of the disclosure. In addition to the embodiments disclosed herein, other modifications based on the technical ideas of the present disclosure are possible, as will be apparent to those of ordinary skill in the art to which the present disclosure belongs. One of ordinary skill in the art will recognize that the nanobionic SERS sensor for detecting airborne analytes, the system comprising the nanobionic SERS sensor, and the method of detecting airborne analytes according to the embodiments described with reference to FIGS. 1 to 9, inclusive, may be subject to various substitutions, changes, and modifications without departing from the technical ideas of the present disclosure. The scope of the disclosure is therefore not to be limited by the embodiments described, but rather by the technical ideas recited in the patent claims.

### INDUSTRIAL APPLICABILITY

Embodiments of the present disclosure may be applied to sensors and applications thereof for detecting substances and methods for detecting substances.

1. A nanobionic surface-enhanced Raman scattering (SERS) sensor for detecting airborne analytes, comprising:
an optical nanosensor placed inside leaves of a plant,
wherein the optical nanosensor comprising:
a first nanostructure;
a second nanostructure comprising metal and being disposed on a surface of the first nanosensor to cause SERS; and
a polymer bonded to the surface of the second nanostructure and being capable of adsorbing the analytes,
wherein the optical nanosensor is configured to detect the analytes introduced into the interior of leaves through stomata of the plant by respiration and interplant communication mechanisms of the plant.

2. The nanobionic SERS sensor of claim 1, wherein the first nanostructure comprises a non-metal, and the first nanostructure has a nanoparticle or nanotube shape.

3. The nanobionic SERS sensor of claim 1, wherein the first nanostructure comprises silica or carbon nanotubes (CNTs).

4. The nanobionic SERS sensor of claim 1, wherein the second nanostructure comprises a plurality of nanoparticles.

5. The nanobionic SERS sensor of claim 1, wherein the second nanostructure comprises at least one of Ag and Au.

6. The nanobionic SERS sensor of claim 1,
wherein the first nanostructure comprises silica nanoparticles,
wherein the second nanostructure comprises a plurality of Ag nanoparticles disposed on the surface of the silica nanoparticles,
wherein the silica nanoparticles configure a core portion, and the plurality of Ag nanoparticles configure a shell portion.

7. The nanobionic SERS sensor of claim 1, wherein the first nanostructure comprises silica nanoparticles, and the second nanostructure comprises a plurality of Ag nanoparticles disposed on the surface of the silica nanoparticles.

8. The nanobionic SERS sensor of claim 1, wherein the polymer comprises at least one of PDDA [poly(diallyldimethylammonium chloride)], PAA [poly acrylic acid], and PVA [poly vinyl alcohol].

9. The nanobionic SERS sensor of claim 1, wherein the analytes delivered to the air comprises a volatile organic compound (VOC).

10. The nanobionic SERS sensor of claim 1, wherein the analytes delivered to the air comprise gas.

11. The nanobionic SERS sensor of claim 1, wherein the analytes delivered to the air comprise a hazardous substance.

12. The nanobionic SERS sensor of claim 1, wherein the analytes delivered to the air comprise a plant-to-plant signaling molecule.

13. The nanobionic SERS sensor of claim 1, wherein the optical nanosensor is disposed at a depth of 15μm or less from the leaves surface of the plant.

14. A system, comprising:
a nanobionic SERS sensor for detecting airborne analytes of claim 1; and
a Raman spectrometer for detecting a SERS signal generated by the nanobionic SERS sensor.

15. A method for the detection of airborne analytes,
preparing an optical nanosensor comprising a first nanostructure, a second nanostructure disposed on a surface of the first nanostructure to cause surface-enhanced Raman scattering (SERS) and comprising a metal, and a polymer bonded to a surface of the second nanostructure and being capable of adsorbing the analytes;
introducing the optical nanosensor into the interior of leaves of a living plant; and
measuring a SERS signal generated by the optical nanosensor introduced inside the leaves of the plant to detect the analytes has been introduced into the leaves through stomata of the plant by respiration and plant-to-plant communication mechanism from the air surrounding the plant.

16. The method of claim 15,
wherein the first nanostructure comprises silica nanoparticles,
wherein the second nanostructure comprises a plurality of Ag nanoparticles disposed on the surface of the silica nanoparticles,
wherein the silica nanoparticles configure a core portion, and the plurality of Ag nanoparticles configure a shell portion.

17. The method of claim 15, wherein the first nanostructure comprises a carbon nanotube (CNT), and the second nanostructure comprises a plurality of Au nanoparticles disposed on a surface of the CNT.

18. The method of claim 15, wherein the polymer comprises at least one of PDDA [poly(diallyldimethylammonium chloride)], PAA [poly acrylic acid], and PVA [poly vinyl alcohol].

19. The method of claim 15, wherein the analytes delivered to the air comprise a volatile organic compound (VOC).

20. The method of claim 15, wherein the analytes delivered by air comprises a gas.

21. The method of claim 15, wherein the analytes delivered to the air comprise a hazardous substance.

22. The method of claim 15, wherein the airborne analytes delivered to the air comprise a plant-to-plant signaling substance.

23. The method of claim 15, wherein the optical nanosensor is disposed at a depth of 15 μm or less from the leaves surface of the plant.
